(19) United States
(12) Patent Application Publication
(10) Pub. No.: US 2011/0307268 A1
(43) Pub. Date: Dec. 15, 2011

(54) Remote Drug Clinical Trials and Safety Monitoring Support System

(75) Inventor: Grigore C. Burdea, Highland Park, NJ (US)

(73) Assignee: Bright Cloud International Corp, Highland Park, NJ (US)

(21) Appl. No.: 13/158,039

(22) Filed: Jun. 10, 2011

Related U.S. Application Data
(60) Provisional application No. 61/353,751, filed on Jun. 11, 2010.

(51) Int. Cl. G06Q 50/00

(52) U.S. Cl. 705/2

(57) ABSTRACT

The present invention includes systems and methods for monitoring effectiveness and safety of a drug treatment program on a patient. The system includes a computer and a control box connected to the computer. The control box can have one or more interfaces for the patient including bio-signal measuring ones. It can also provide multiple interfaces for the patient. The system also includes a drug dispenser connected to the computer. The drug dispenser can be connected through the control box or directly to the computer. The drug dispenser records a time and a dosage of a drug taken by the patient and the computer executes game software that allows the patient to play a game, the game being based on input to the control box provided by the patient. The computer can be connected to a server that controls overall operation of the system. Server received further input from authorized physicians, drug company researchers or drug safety monitoring specialists of government agencies.

### CROSS REFERENCE TO RELATED APPLICATIONS

The present application claims the benefit of U.S. Provisional Patent Application Ser. No 61/353,751, filed on Jun. 11, 2011, which is incorporated by reference herein in its entirety.

### BACKGROUND OF THE INVENTION

Human clinical trials are part of new drug development (following trials on animals). Typically, the company developing a new drug contracts with physicians, who recruit participants in the trials (clients), based on the disease the new drug is supposed to address. The new drug is administered over a set time period, and clinical data are collected on the effect of the drug on humans. Subsequently these findings are submitted to the drug company headquarters. Initially such data were collected on paper.

Drug safety monitoring follows FDA approval of a new drug. FDA undertakes surveillance of risks from medications after they've won the agency's approval. FDA can require companies to conduct post-marketing research to address safety questions [FDA 2011]. These FDA post-marketing evaluations are performed 18 months after approval of the drug or after its use by 10,000 individuals, whichever is later. Today drug safety data is based on reports from consumers, physicians, and the drug companies themselves, concerning “adverse events” and side effects of new medication intake.

Kumar et al. (U.S. Pat. No. 7,188,151) teaches the remote monitoring of bio-signals through a device at the patient's side transmitting data (including alarms) to devices at the provider's side using the internet. Communication is mediated by an “engine” which stores and retransmits data. Such data does not refer to drug trials or new drug safety monitoring. Furthermore, there is no mention of games used to mediate interactions at the patient's side, nor of cell phone use.

Hyde et al (U.S. Pat. No. 7,801,686 B2-2010) teaches a system that remotely monitors patient bio-signals and abnormal physiological measures of a patient and uses databases to present possible prescription medication to address the medical condition. Among other means of detection of bioactive agent (substance) use by an individual this patent teaches that the detector module may look at virtual reality and game interactions. An alterer module then modifies aspects of the artificial sensory experience to counteract the effects of the bioactive agent. The interaction refers to multi-modality (image, sound, graphics, smell, taste). The simulation can run on a mobile device.

Farlick et al (U.S. Pat. No. 7,856,264 B2-2010) teaches the use of an implantable drug delivery device controlled in real time as a function of performance of the patient interacting with a robot and other computer interfaces connected to a computer. This includes virtual reality interactions.

In recent years clinical data on the drug effect on clients are stored as electronic records on a server. Data in the server are then accessed remotely over the Internet by the drug company team. Mitchel et al. [2010] illustrates the transfer of data from the client's computer to the server database, and from the server database to the drug company database over the Internet. A permission mechanism gives the physician participating in the study more independence in granting access to the clinical data (electronic health records).

Another important component of drug trials is the compliance of the client in taking the medication. Such compliance can be verified if client if hospitalized for baseline measures and during the delivery of new medication (usually over short hospital stays) [National Institute of Allergy and Infectious Diseases, 2008], or if the client travels to physician's office, where the experimental drug is then administered. If the medication is taken in the client's home without direct supervision from a visiting nurse, then a number of commercially available medication reminder devices can be used. They include the “e-Pill Beep-and-Tell” electronic medicine bottle cap [Medication Reminders, 2010a]. A recent version of medicine reminder equipment has a remote monitoring feature. The “e-Pill MedSmart PLUS Monitored” [Medication Reminders, 2010b], has a rotating (and locked) tray that notifies a remote party if the client has missed to take the dose. Such notification can be sent out by voice or text (to a cell phone) or by email.

### SUMMARY OF THE INVENTION

The present invention involves the use of a virtual reality system for drug efficacy measurement. Part of the system is a drug dispenser that transmits information to an electronic box interfaced to a computer in the client's home. The same computer transmits drug intake information over the Internet to a remote computer (server or cloud clusters) that can be at a clinic/physician's office, at drug company headquarters, or at FDA.

In accordance with one aspect of the present invention, a system for monitoring effectiveness and safety of a drug treatment program on a remote patient is provided. The system includes a computer and a control box connected to the remote computer, the control box having one or more interfaces for the patient. The system also includes a drug dispenser connected to the remote computer. The drug dispenser records a time, a drug type and a dosage of that drug taken by the patient and the remote computer executes game software that allows the patient to play a game, the game being based on input to the control box provided by the patient.

In accordance with a further aspect of the present invention, the computer executes the game software during a time when the drug takes effect on the patient and system includes a server connected to the remote computer via a network connection, wherein the computer provides the time, drug type and the dosage of that drug taken by the patient as well as game performance data. Game performance data includes such variables as hit points, level of game, movement peak velocity, time-on-level (time taken to complete a level), errors, accuracy of target, number of trials, and other such variables. In accordance with another aspect of the present invention, the patient enters user information into the remote computer and the remote computer grants access to games, and simultaneously uploads the user information to the server. Also, the server includes analytical software that examines game performance data over time to analyze drug effect and safety. Further, the drug dispenser can also dispense the drug to the patient. The control box can includes a pedal, video camera, sensing gloves, voice input, robotic arms, sensing balls, trackers, haptic devices, grippers and a joy stick to allow the patient to play the game. The control box can be a cell phone that incorporates said camera, as well as other built-in sensors use in the game (touch sensor, accelerometer) and output feedback such as sound, graphics and vibrations. In such embodiment the cell phone communicates with the remote server wirelessly.

In accordance with another aspect of the present invention, the server has a login capability that is provided to physicians, pharmaceutical representatives, drug safety monitoring specialists and government regulatory agencies (such as FDA) to allow them to access game performance data.

The computer can change a difficulty of the game software being executed. This change can be made in accordance with game performance data, in accordance with the drug dosage, or in accordance to remote “override” commands received from the server.

The computer can withdraw permission of the patient to take the drug based on game performance data or override commands.

In accordance with a further aspect of the present invention, the server provides an interface to a plurality of patients, and their remote computers, allowing two or more of the plurality of patients to play against each other, and the remote computers provide game performance data related to the plurality of patients playing against each other to the server.

It is appreciated that a remote server may have several groups of patients play different games, in situations when several remote clinical trials or drug safety monitoring trails occur simultaneously and are “hosted” on the same server. In this embodiment server encompasses software that separates the different groups and trials, such that a patient from a group designated to a given new drug cannot play against a patient belonging to a group designated to another new drug.

In accordance with another aspect of the present invention, the remote computer allows the patient to play a game provided by the game software before and after the patient has taken the drug and the computer generates game performance “differential” data before and after the drug has been consumed by the patient.

Methods of providing the above steps using a processing system are also contemplated.

### DESCRIPTION OF THE DRAWINGS

FIG. 1 illustrates a system in accordance with one aspect of the present invention.

FIG. 2 illustrates a system in accordance with another aspect of the present invention wherein interfaces to a plurality of patients is provided.

FIG. 3 illustrates a system in accordance with a further aspect of the present invention wherein games a played on a cell phone.

FIG. 4 illustrates steps taken by the system of the present invention in accordance with one aspect of the present invention.

FIG. 5 illustrates an Internet-based system in accordance with an aspect of the present invention.

### DESCRIPTION

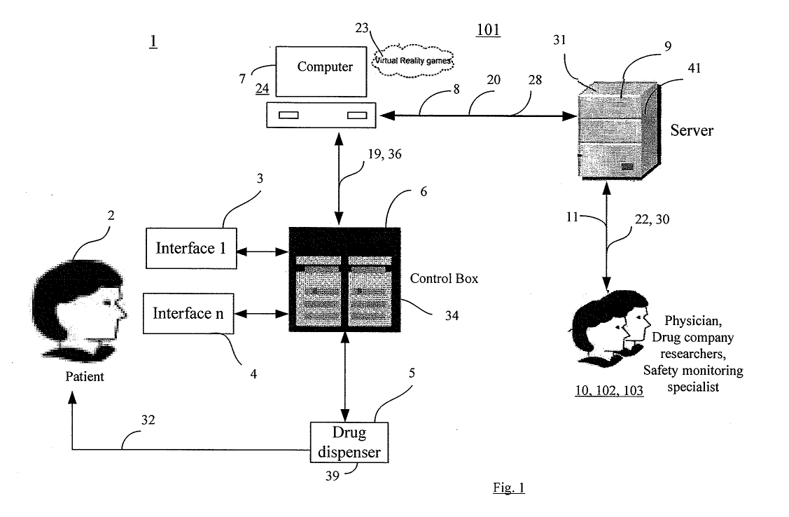

The invention, shown in part in FIG. 1, is a system 1 and method 101, by which virtual reality games 23 are integrated to support clinical trials of new medication, or to help monitor the effect of newly approved drugs (as part of safety trials).

The client/patient 2 interacts with control box 6 through a number of interfaces 3, 4. Such interfaces may be sensing gloves, pedals, video cameras, joy sticks, robotic arms, and others known in the art. It is further envisioned that such interfaces can include bio-signal measuring devices (blood pressure and pulse meters). Control box 6 also receives input from a drug dispenser 5 (such as those commercially available), to verify client 2 has first taken the experimental or newly approved drug dose 32. Only after this step is completed, will electronic box 6 allow the interfaces 3 to 4 to input data into virtual reality games 23 running on computer 7.

Computer 7 has scheduler software 24, to sequence and gradate the virtual reality games 23 that patient 2 is asked to play. During play, computer 7 samples transparently and stores game performance information 20 locally. Game performance information 20, together with drug intake (compliance) information 19 obtained from control box 6 are transmitted over internet connection 8 to remote server 9. It is appreciated that server 9 can be one computer or a multitude of computers. Abnormal bio-signal data 301 detected by control box interfaces are similarly relayed to remote server 9.

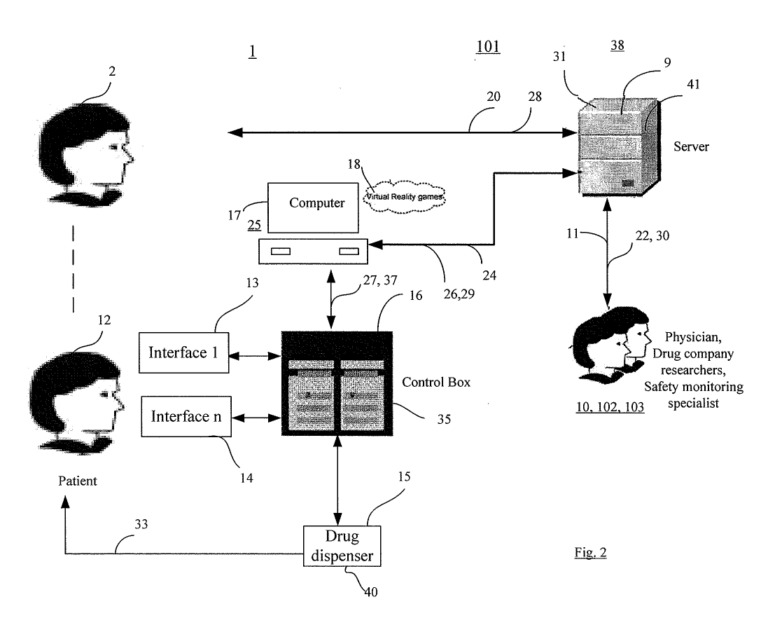

As illustrated in FIG. 2, a multitude of other patients 12 enrolled in the same experimental drug trial, or in the same safety monitoring of a newly-approved drugs, will similarly interact with virtual reality games 18 running on remote computers 17. Such interaction will be conditioned by control boxes 16 based on information from dug dispensers 15 indicating that patients 12 have also taken the prescribe medication dose 33.

Computers 17 will similarly have scheduling software 25 to gradate virtual reality games 18, and will transparently measure game performance 26 after drug intake 33. Computer 17 will similarly transmit game performance 26 together with drug intake compliance information 27 to remote server 9 using internet connection 24. It is appreciated that virtual reality games 18 played by patients 12 are the same as virtual reality games 23 played by patient 2, and are designated by drug company researchers 102, or drug, safety specialists 103 for a particular drug being studied.

Abnormal bio-signal data 302, sensed by interfaces 13, 14 are similarly sent to remote server 9.

It is further envisioned that virtual reality games 23 and 18 could be single player, or multiplayer, in which case it will be possible for patients 2 and 12 to play together. It is further envisioned that control boxes 6 and 16 can have settings 34, 35 by which patients 2 and 12 are allowed to play before taking medication, as well as after. The settings 34 and 35 will allow play of games 23 and 18 regardless of whether such games are single-player or multiplayer. In this embodiment, game play differential performance data (before drug, after drug intake) 28 and 29 will also be transmitted to remote server 9 over internet connections 8 and 24.

Game play differential data 28 and 29 will be stored on server 9 and analyzed by drug efficacy analysis software 31 and by drug safety monitoring software 41. Such software will use game play differential data 28 and/or 29 to gauge effect of drug dose 32 and 33. In order to determine effect, drug compliance information 19 and 27 will have a time stamps 36 and 37, respectively. Drug efficacy analysis software 31 will use time information given by time stamps 36 and 37 to determine delay 38 in patient 2 or patient 12 responses to drug dose 32 or 33. Drug safety monitoring software 41 will use information on abnormal bio-signals 301 and 302 to recommend denying further access to patients 2, 12 by communicating to physicians 10, drug company researchers 102 and safety monitoring specialists 103 such abnormal values 301, 302.

Physician 10, drug company researchers 102, and safety monitoring specialists 103 will connect from time to time to remote server 9 using internet transmission 11. They will observe game performance information 20 26, differential performance information 28 and 29, results of drug efficacy analysis software 31, and of drug safety analysis software 41. In response, physicians 10, drug company researchers 102 or drug safety monitoring specialists 103 have the ability to transmit game change setting information 22 and medication dosage change info 30 to server 9. They can also accept the input from safety monitoring software 41, and issue an access denying command 304. Once such command is received by remote computers 7, 17, their respective patients 2, 12 will not be allowed to continue taking the drug and playing the virtual reality games 18, 23.

The game settings (difficulty levels, length, input modality, features) info 22 will be relayed by server 9 to computers 7 and 17 affecting the way patients 2 and 12 will play the next time. Medication dosage change 30 will be relayed to control boxes 6 and 16 by server 9, through computers 7, 17, affecting the dosage 32 and 33 to be taken by patients 2 and 12 the next time. In this embodiment it is understood that drug dosage 32 and 33 encoded in drug dispensers 5 and 15 will include timing information 39 and 40, respectively.

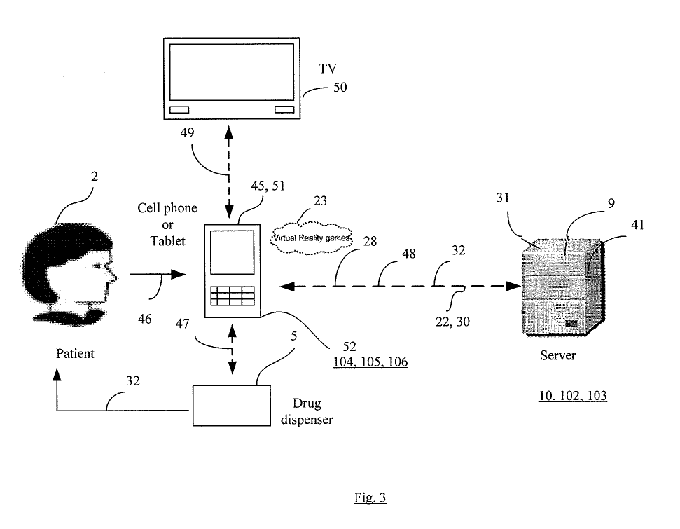

In another embodiment, illustrated in FIG. 3, patient 2 plays games on a cell phone 45 or tablet computer 51 through manual interaction 46. Manual interaction 46 may be the start of virtual reality games 23 played on the cell phone 45 or tablet 51. The games 23 are played using the device internal sensors 52, such as accelerometers 104, camera 105, GPS 106, and others of the type known in the art. Resulting game graphics may be displayed on the cell phone 45 or table 51, or transmitted through a wireless connection 49 to a TV 50, to provide larger images. Cell phone 45 or tablet 51 are also in wireless communication 47 with drug dispenser 5. This way drug dispenser 5 sends cell phone 45 or tablet 51 information on medication dosage 32 taken by patient 2. Cell phone 45 or table 51 sends medication dosage 32 and game differential performance information 28 to remote server 9 over a wireless connection 48. Server 9 analyses these data transmitted by cell phone 45 or tablet 51 using its resident drug efficacy analysis software 31 and drug safety analysis software 41. Game change settings 22 and new medication dosage 30 are then sent to cell phone 45 or tablet 51 over wireless connection 48. Medication dosage information 30 is then downloaded to drug dispenser 5 which alters medication 32 taken by patient 2.

It is envisioned that physician 10, drug company researchers 102 or drug safety specialists 103 may decide to deny access to patient 2 by issuing an override command 304 to server 9. Such access denying command 304 is then relayed through the wireless connection 49 to cell phone 45 or tablet 51. This command 304 is then preventing dispenser 5 from issuing further dosage 32 of new drug, and cell phone 45 or tablet 51 from allowing patient 2 from playing games 23.

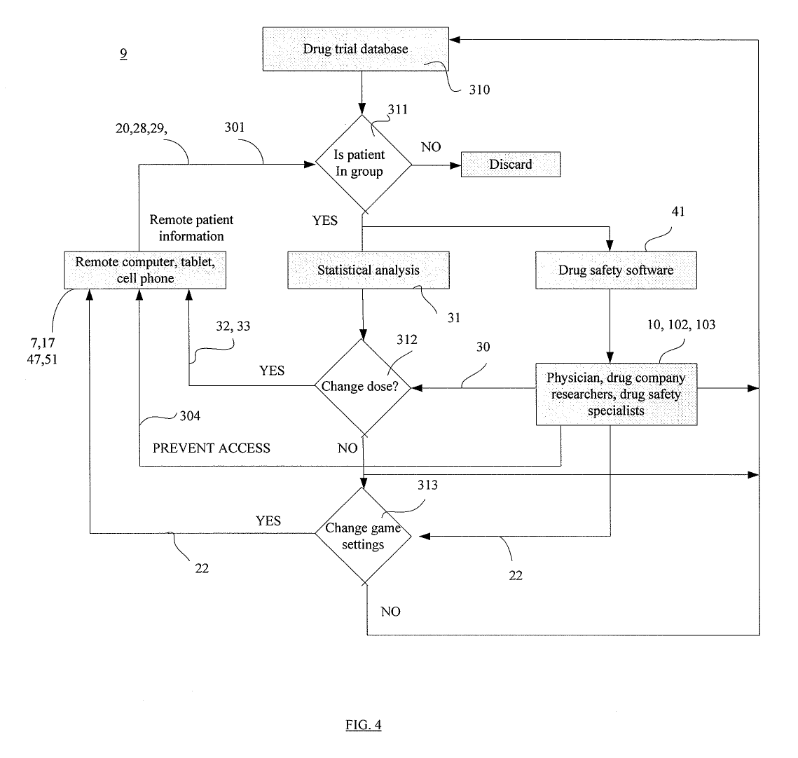

FIG. 4 illustrates a block diagram of the system software, with the steps taken in accordance with an aspect of the present invention. Drug trial cohort database 310 contains the names (coded) of the multitude of patients 2, 12, participating in the drug trials. Upon login computers 7, 17, cell phone 45 or table 51 send login information to remote server 9. Here a validation block 311 compares the patient identity code with the data in the trial database 310 to determine if this is an approved patient. If yes, the rest of the data (game performance data 20, 28, game differential data 29, 31, and bio-signals data 301) transmitted to server 9 is accepted for analysis. If not these data is discarded.

Statistical analysis software block 31 then looks at the game date for statistical purposes and send results to a dosage change block 312. If a change is needed in the dosage, then block 312 will send new dosage information 32, 33 to remote computers 7, 17, or cell phone 45, or tablet 51. If no dosage needs change the game data is sent to a game setting changer block 313 which sets new setting values 22 for games 18, 23 and transmits them to the remote computers 7, 17, or cell phone 45, or tablet 51.

The same game data 20,28,29,31 and bio-signal data 301 accepted by validation block 311 is sent to drug safety software block 41. Based on these data drug safety block 41 may decide to inform physicians 10, drug company researchers 102 or drug safety specialists 103 upon abnormal values. They may terminate access to patient 2, 12 by issuing an override command 304 relayed by software block 41 to remote computers 7, 17, or cell phone 45, or tablet 51. The same information (termination 304) is logged into drug clinical database 310.

Physicians 10, drug company researchers 102 or drug safety specialists 103 may also decide to change game settings 30 transmitting the command to game setting change block 313, or may decide to change the new drug dosage 30 by transmitting the information to the dose changer block 312. New drug doses 32,33 and new game settings 22 are then sent to the remote computers 7, 17, or cell phone 45, or tablet 51.

Thus, one aspect of the present invention provides a system for monitoring effectiveness and safety of a new drug treatment program on a patient. The system includes a computer, a control box, a drug dispenser. The control box is connected to the computer and has one or more interfaces for the patient. One of these interfaces may sample patent 2 bio-signals. The drug dispenser is connected to the computer 7, typically through the control box 6. The drug dispenser 5 records a time and a dosage of a drug taken by the patient and the computer executes game software 18, 23 that allows the patient to play a game, the game being based on input to the control box provided by the patient.

The computer can be a personal computer (PC), a tablet computer, a laptop. The computer executes game software. The game software can be stored once it is downloaded from a server. The game software is approved by the physician 10, drug company researcher 102 or drug safety specialist 103, such that it corresponds to the particular new drug being studied. In accordance with an aspect of the present invention, the game software is executed during a time when the drug takes effect on the patient. The game software can also be executed at other times, for baseline comparisons. It is envisioned that new drug dosage 32, 33 need to be taken and games 18, 23 need to be played about the same time of day, every day.

The control box, such as an electronic box powered by the house main, and can have input for a number of user interfaces. For example, it can include inputs from a pedal, video camera, sensing gloves, voice input, robotic arms, sensing balls, trackers, haptic devices, grippers, a joy stick and any combination thereof. All of these devices are well known. In addition the control box gets input from bio-signal interfaces measuring blood pressure and pulse, such as those commercially available.

As already explained, in one embodiment of the present invention, the control box can be a cell phone. The game software can execute on the cell phone and the patient can play games on the cell phone while undergoing drug treatment. The cell phone can report the results of the game in a game performance data packet to either the a remote server.

The drug dispenser can be one known in the art, such as a rotating, lockable turret, with a wireless link for remote communication. For example this could be a e-pill MD2 PLUS Monitored Locked Automatic Pill Dispenser, which can send email on drug dispensing to a cell phone (http://www.amazon.com/dp/B00020BKA2/ref=asc_df_B00020BKA21531788?smid=AMQ LGT88G08LK&tag=nextagusmp037223520&linkCode=asn&creative=395105&creativeASI N=B00020BKA2). It is easy to understand how this can be integrated with cell phone 45 in the present invention.

The drug dispenser can actually dispense the drug to the patient, noting automatically the drug, the dosage and the time the drug is dispensed. It can also note that the drug was actually taken by the patient.

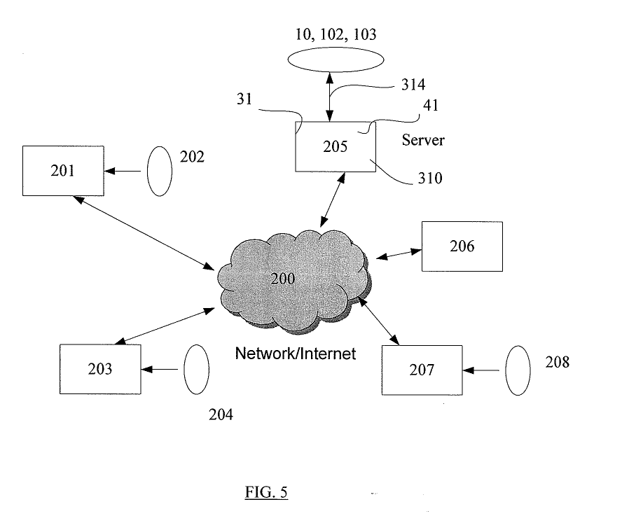

The system of the present invention can also include a server connected to the computer via a network connection. As illustrated in FIG. 5, the server can be connected to a plurality of computers. Referring to FIG. 5, a server 205 is connected to a plurality of computers 201, 203, 206 and 207 via the Internet 200 or any other network. The computer 201 has a control box 202. The computer 203 has a control box 204. The computer 206 has a control box 210. The computer 207 has a control box 208. Each of the computers 201, 203, 206 and 207 provides patient information, the drug taken by the patient, the dosage of the drug taken and the time the drug was taken by the patient and game performance data for each patient.

In accordance with one aspect of the present invention, the patient enters user information into the computer and the computer provides the user information to the server. Patient entry data at log in includes user name (code ID), password and drug symbol (code for drugs not on market yet). If patient is not remembering password, such information can be retrieved from server 9 using autentification software, as known in the art. If patient fails to log in corrected a set number of times, patient account is locked. Similarly, if patient inputs the wrong drug name or drug code, repeatedly, even with correct password, then the account is locked.

In accordance with one aspect of the present invention, the server 9 or 205 includes analytical software 31 that examines game performance data over time, and software 41 that analyzes drug safety. There are several pieces of software in the server. One analyzes statistics looking for speed of effect of the drug. The software variables depend on the drug. If a drug causes sleepiness, then that will be reflected in the game performance data. This software looks at the person, time of day, the game level and the performance on the game. For this data, trends or effects can be inferred. As another example, if the drug effects vision, then if game performance is improved, then one can infer that the drug is effective because the patient 2 can better see the game graphics and thus better play the game. Software also looks for drug safety. This software looks at the bio data, including blood pressure and pulse. This software can execute an override command to cut off the drug from the patient.

The system of the present invention also provides a login capability on the server so that physicians 10, pharmaceutical representatives 102 and drug safety monitoring specialists 103 from government regulatory agencies can log into the server. They can enter a drug trial identification number, which in accordance with an aspect of the present invention, all the information entered by a patient is tagged with in the drug trial database 310. By doing so, these entities and individuals can review the game performance data, the time the applicable drug was taken, the dosage and the analytical results to determine the drug's safety and effectiveness.

The server can change a difficulty of the game software being executed. This can be done based on the game performance data.

The computer or the server can withdraw permission of the patient to take the drug based on game performance data, based on override commands 314 received from physicians 10, pharmaceutical representatives 102 and drug safety monitoring specialists 103. As discussed above, the system of the present invention Include multi-play between patients involved in the same drug clinical trial. In this case, the server can monitor the game results from a plurality of patients individually. Additionally the computers can allow two or more of the plurality of patients to play against each other, and their computer provides game performance data related to the plurality of patients playing against each other to the server. The server software includes software that logs games performance from several patients, in a time sequenced way in the drug trial database 310.

In accordance with another aspect of the present invention, the system of the present invention allows the patient to play a game provided by the game software before and after the patient has taken the drug and the computer generates game performance data before and after the drug has been consumed by the patient.

Various methods are contemplated by the present invention. One method involves monitoring the effectiveness and safety of a drug treatment program on a patient by a processor recording the time and dosage a drug is consumed by the patient, the processor executing game software to allow the patient to play a game on the processor during a time when the drug takes effect on the patient and the processor generating game performance data based on the patient playing the game.

The game can be based, in part, on input provided to the processor by the patient.

In the method, the processor reports the patient's identity, the patent's game performance data, the drug taken by the patient, the time the drug was taken by the patient and the dosage of the drug taken by the patient to a server, the server receiving this information from a plurality of processors monitoring a plurality of patients playing games and the server evaluating the safety and effectiveness of the drug based on this information.

The following references are hereby incorporated by reference:

(1) Jules T. Mitchel, Yong Joong Kim, Joonhyuk Choi, Glen Park, Laura Suciu, Mark Horn, The Final eFrontier. Applied Clinical Trials Online. May 1, 2010, found at http://appliedclinicaltrialsonline.findpharma.com/appliedclinicaltrials/CRO%2FSponsor/The-Final-eFrontier/ArticleStandard/Article/detaiI/668520;

(2) FDA Postmarketing Drug Safety Evaluations. May 13, 2011 http://www.fda.gov/Drugs/GuidanceComplianceRegulatoryInformation/Surveillance/ucm204 091.htm;

National Institute of Allergy and Infectious Diseases (NIAID) A Pilot Study of Methodology to Rapidly Evaluate Drugs for Bactericidal Activity, Tolerance, and Pharmacokinetics in the Treatment of Pulmonary Tuberculosis Using Isoniazid and Levofloxacin. Aug. 6 2008. http://clinicaltrials.gov/ct2/show/NCT00000778

(3) e-Pill Medication Reminders. e-Pill Beep-n-Tell http://www.epill.com/beeptell.html

(4) e-Pill Medication Reminders. E-Pill MedSmart Plus Monitored http://www.epill.com/medsmartplus.html.

e-pill MD2 PLUS Monitored Locked Automatic Pill Dispenser http://www.amazon.com/dp/B00020BKA2/ref=asc_df_B00020BKA21531788?smid=AMQL GT88G08LK&tag=nextagusmp0372235-20&linkCode=asn&creative=395105&creativeASIN=B00020BKA2

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A system for monitoring effectiveness and safety of a drug treatment program on a patient, comprising:
a computer;
a control box connected to the computer, the control box having one or more interfaces for the patient;
a drug dispenser connected to the computer;
wherein the drug dispenser records a time and a dosage of a drug taken by the patient and the computer executes game software that allows the patient to play a game, the game being based on input to the control box provided by the patient.

2. The system of claim 1, wherein the computer executes the game software during a time when the drug takes effect on the patient.

3. The system of claim 1, wherein the system comprises a server connected to the computer via a network connection, wherein the computer provides the time and the dosage of the drug taken by the patient and game performance data.

4. The system of claim 2, wherein the patient enters user information into the computer and the computer provides the user information to the server.

5. The system of claim 4, wherein the server includes analytical software that examines game performance data over time to analyze drug effect and safety.

6. The system of claim 1, wherein the drug dispenser also dispenses the drug to the patient.

7. The system of claim 1, wherein the control box includes a pedal, video camera, sensing gloves, voice input, robotic arms, sensing balls, trackers, haptic devices, grippers, a joy stick and bio-sensing interfaces (blood pressure, pulse).

8. The system of claim 1, wherein the control box is a cell phone.

9. The system of claim 2, wherein the network connection is an Internet.

10. The system of claim 1, wherein the computer is connected to the drug dispenser through the control box.

11. The system of claim 2, wherein a login capability to the server is provided from physicians, pharmaceutical representatives and drug safety monitoring specialists of government regulatory agencies.

12. The system of claim 1, wherein the computer changes a difficulty of the game software being executed.

13. The system of claim 1, wherein the computer withdraws permission of the patient to take the drug based on game performance data and commands received from remote server.

14. The system of claim 2, comprising the control box providing an interface to a plurality of patients, and the remote server allowing two or more of the plurality of patients to play against each other on games specified for a given new drug testing, and the server collects game performance data related to the plurality of patients playing against each other to the server.

15. The system of claim 1, wherein the computer allows the patient to play a game provided by the game software before and after the patient has taken the drug and the computer generates game performance data before and after the drug has been consumed by the patient.

16. A method of monitoring effectiveness and safety of a drug treatment program on a patient, comprising:
a processor recording the time and dosage a drug is consumed by the patient;
the processor executing game software to allow the patient to play a game on the processor during a time when the drug takes effect on the patient;
the processor generating game performance data based on the patient playing the game.

17. The method of claim 16, wherein the game is based in part on input provided to the processor by the patient.

18. The method of claim 16, wherein the processor reports the patient's identity, the patent's game performance data, the drug taken by the patient, the time the drug was taken by the patient, the dosage of the drug taken by the patient and patient bio-signals to a server, the server receiving this information from a plurality of processors monitoring a plurality of patients playing games and the server evaluating the safety and effectiveness of the drug based on this information.

19. The method of claim 16, wherein a drug dispenser attached to the processor dispenses the drug to the patient under supervision of said computer.

20. The method of claim 16, wherein the patient plays the game through one or more of the following interfaces: a pedal, a video camera, a sensing gloves, a voice input device, a robotic arm, a sensing ball, a tracker, a haptic devices, a gripper and a joy stick.
